(19) United States
(12) Patent Application Publication
(10) Pub. No.: US 2009/0229974 A1
(43) Pub. Date: Sep. 17, 2009

(54) Tamian fusion cell

(76) Inventor: Richard Tamian, Sparta, NJ (US)

Correspondence Address: RICHARD TAMIAN, 69 EDISON TERRACE, SPARTA, NJ, 07871, US

(21) Appl. No.: 12/075,929

(22) Filed: Mar. 15, 2008

(51) Int. Cl. C25B 9/00; C25B 11/04; C25B 11/03; G21B 3/00

(52) U.S. Cl. 204/272; 204/279; 204/289; 204/284; 976/DIG. 3

(57) ABSTRACT

The Tamian Fusion Cell is a uniquely designed electrolytic cell that promotes the process of nuclear fusion. The cell consists of an outer cylinder whose inner surface is lined with palladium (Pd), a middle cylinder of platinum (Pt), which acts as an ion “kicker”, and a central palladium (Pd) electrode post. The middle (Pt) cylinder is perforated, allowing for the electrolyte and ions to flow from the outer cell chamber through these holes to the inner cell chamber and vice versa. A dual-polarity, direct current power supply is connected to the cell by either a “double-pole double-throw” switch or by an “integrated timing circuit”. The purpose of the I.C. timing circuit or switch is to periodically reverse the polarities of the cell's palladium electrodes, which creates a fluctuating ion flow, whereby promoting constant fusion at the negative palladium electrode. The electrolyte is composed of (LiOD) Lithium deuterium oxide, (H₂O) water, heavy water (D₂O), (HCl) dilute Hydrochloric Acid, and added (³H⁺) tritium ions. When an electric current is passed through this electrolytic bath, the positive deuterium ions D⁺ will accelerate toward the negative (Pd) palladium electrode by the “ion kicker”, causing them to collide and fuse within the palladium metal's crystal lattice structure forming a helium (⁴He) atom and energy. Water tubes situated within the cell transfer this heat energy to an operational heat exchanger device located outside the cell.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF INVENTION

In March 1989, Stanley Pons and Martin Fleischmann at the University of Utah declared they successfully produced cold-fusion. Their apparatus consisted of a simple electrolytic cell connected to a battery using an electrolyte containing heavy water. However, other researchers and experimenters could not reproduce any consistent fusion results using their data. By using the Tamian Fusion Cell, which is a uniquely designed electrolytic cell, problems associated with the Pons-Fleischmann cell can be eliminated. For example, one major problem that prevents fusion from occurring is the buildup of deposits on the negative palladium electrode. The Tamian Fusion Cell solves this situation by alternating the fusion process between two palladium electrodes, so while fusion is occurring at the negative palladium central post electrode, the outer positive cylindrical palladium electrode is being cleaned by escaping (O₂) gas, bubbling out of solution. When the “double-pole double-throw” switch is toggled to position “B” this process reverses, causing fusion to occur at the outer (Pd) electrode while the center (Pd) electrode now gets cleaned. Another advantage of the Tamian Fusion Cell is its middle cylindrical platinum (Pt) electrode that performs as an ion “kicker”, which accelerates the positive deuterium (D⁺) ions to the negative (Pd) palladium electrode causing maximum impact with the medal (Pd) surface. Adding more force to the (D⁺) ions, increases the chances for the fusion process to occur. Another advantage, offered by the Tamian Fusion Cell, is the use of thin palladium villi, protruding laterally from the (Pd) electrode surfaces into the electrolytic bath, which increases the surface area for a greater occurrence of deuterium fusion.

### BRIEF DESCRIPTION OF THE DRAWINGS

FIG. 1 is a simplified view of the electrolytic cell according to the invention, shown in partial section, illustrates an outer cylindrical casing of plastic 23 with an inner lining made of palladium 25. A middle perforated cylinder made of platinum 26 also having a plastic base sits inside the outer palladium (Pd) cylinder 25. Placed in the center of the cell and in the center of the platinum (Pt) cylinder is a palladium electrode post 24 also having a plastic base. The outer cell chamber 27, located between the outer palladium cylindrical electrode 25 and the middle platinum cylindrical electrode 26, and an inner cell chamber 28, located between the middle platinum cylindrical electrode 26 and the central palladium electrode post 24, are both filled with an electrolytic bath composed of (LiOD) Lithium deuterium oxide, (H₂O) water, heavy water (D₂O), (HCl) dilute Hydrochloric Acid, and added (³H⁺) tritium ions. The electrolyte flows between the outer chamber 27 and the inner chamber 28 and vice versa through perforated holes in the middle platinum (Pt) cylinder. An electric current is supplied to the cell by a “dual-polarity power supply” 20; which is connected to the center palladium post electrode 24, the outer cylindrical rim palladium electrode 25, and the middle platinum cylindrical electrode 26, by a “double-pole double-throw” (D.P.D.T.) switch 21. When the (D.P.D.T.) switch 21 is placed in position “A”, the voltage polarity to the three electrodes are designated as shown. The load resistors 22 and the plastic bases are used to prevent any electrical short-circuiting. Thin palladium villi 29 protrude laterally from the palladium electrodes which increase the surface area of said electrodes for a greater occurrence of deuterium fusion.

FIG. 2 is a simplified view of the electrolytic cell according to the invention, shown in partial section, with the “double-pole double-throw” (D.P.D.T.) switch 21 toggled in position “B”, which reverses the voltage polarities of the two palladium electrodes as shown.

FIG. 3 is a simplified view of the electrolytic cell according to the invention, shown in partial section, illustrates the water tube network, wherein a pump 31 pumps water through a set of tubes 32. One tube runs through the axial center of the central palladium electrode post 24, while other tubes pass behind the cylindrical palladium rim electrode 25, while others may spiral around the circumference of the cell. Heat generated by deuterium fusion is transferred to the water in these tubes which travel to a heat exchanger device 33 located outside the cell.

FIG. 4 is a simplified top view of the electrolytic cell, according to the invention, illustrating the outer palladium (Pd) cylindrical electrode 25, the middle platinum (Pt) cylindrical electrode 26, the central palladium (Pd) electrode post 24, and a water tube heat transfer network 32.

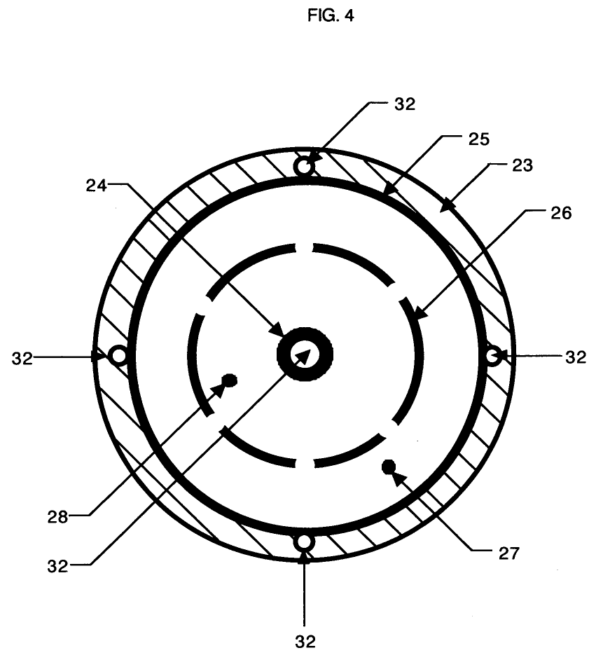

FIG. 5 is a simplified view of the electrolytic cell according to the invention, shown in partial section, illustrates the type and the charge of the ions that dissociate from the electrolytic bath when an electric current passes through said bath. The positive ions, which are ⁶Li⁺, D⁺, H⁺, and ³H⁺, will all move toward the negative palladium (Pd) electrode, which is the central post electrode when the (D.P.D.T.) switch is in position “A” or they will move toward the outer rim cylindrical palladium electrode when the switch is in position “B” (not shown). Likewise the negative ions, which are O⁻+Cl⁻, will move toward the positive (Pd) electrode, which is the outer rim palladium electrode when the (D.P.D.T.) switch is in position “A” or they will migrate toward the central electrode post when the (D.P.D.T.) switch is in position “B” (not shown). Diatomic gases, such as Cl₂, O₂, H₂, and D₂ will form and bubble out of solution, while lithium will combine with chlorine and form LiCl which will precipitate out of the bath. Two deuterium ions will fuse together within the surface of the negative palladium electrode and produce helium which will also bubble out of the solution as a gas.

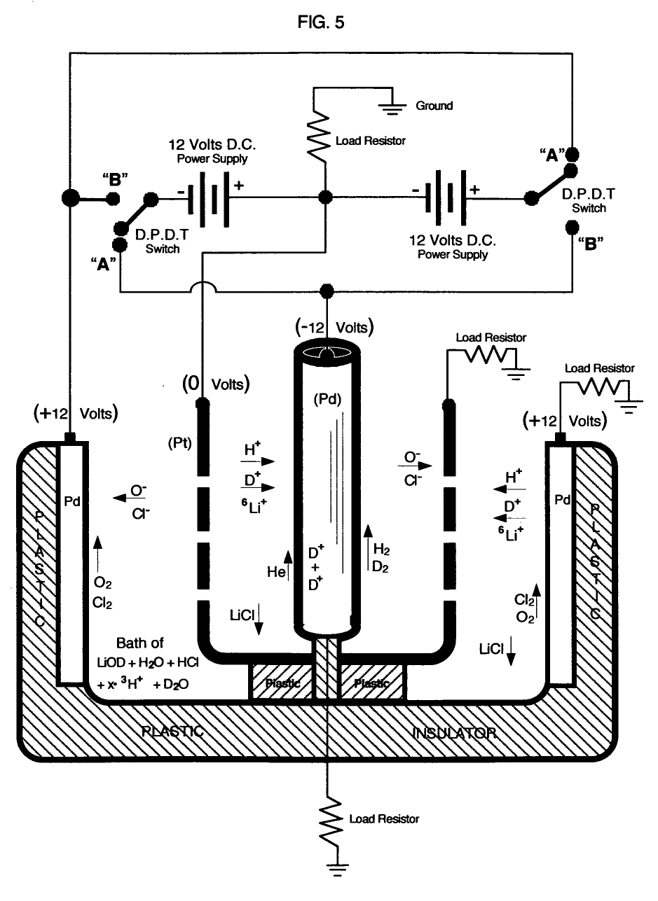

### DETAILED DESCRIPTION OF THE INVENTION

The Tamian Fusion Cell is a uniquely designed electrolytic cell that promotes the process of deuterium-fusion. The cell consists of an outer cylinder lining of palladium (Pd) 25, a middle cylinder of platinum (Pt) 26, and a central electrode post of palladium (Pd) 24. The middle (Pt) cylinder is perforated, allowing for the electrolytic bath and ions to flow from the outer cylindrical (Pd) lining through the outer bath chamber 27, through the inner bath chamber 28 to the center (Pd) electrode post and vice versa. A dual-polarity, direct current power supply 20 is connected to the cell by either a “double-pole double-throw” (D.P.D.T.) switch 21 or by an integrated timing circuit (not shown). The purpose of the (D.P.D.T.) switch or I.C. timing circuit is to periodically reverse the polarity of the cell's palladium electrodes, whereby controlling and maintaining a constant deuterium fusion reaction. The electrolyte is composed of (LiOD) lithium deuterium oxide, (H₂O) water, heavy water (D₂O), (HCl) dilute Hydrochloric Acid, and added (3H⁺) tritium ions. When an electric current is passed through the electrolytic bath, the electrolyte dissociates into ions. The positive deuterium ions D⁺ migrate to the negative (Pd) palladium electrode and fuse together within the metal's crystal lattice structure creating a helium (⁴He) atom and energy. Water tubes 32 situated inside and outside the cell transfer this heat energy to a heat exchanger device located outside the cell.

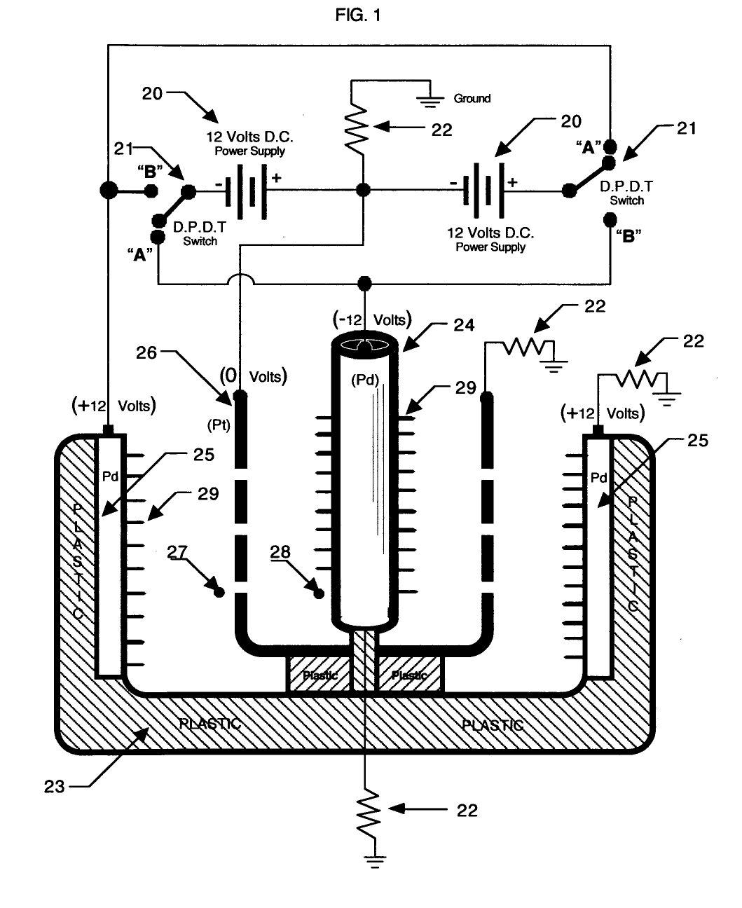

When the “double-pole double-throw” switch (D.P.D.T.) is toggled to position “A”, FIG. 1, direct current flows from the positive terminal of the power supply to the outer (Pd) cylindrical electrode lining, making it a positive ⁺12 volts. The negative terminal of the power supply connects to the center (Pd) electrode post, making it a negative ⁻12 volts. The ground lead of the power supply is connected to the middle (Pt) platinum cylinder electrode making it a zero volt potential. However even though this (Pt) terminal is the ground lead of the cell, it is negatively charged relative to the outer (Pd) cylinder lining and positively charged relative to the center (Pd) electrode post.

When an electric current flows through the cell, the following ions will dissociate from the electrolytic bath: ⁶Li⁺+2O⁻+2D⁺+2H⁺+D⁺+O⁻+Cl⁻+3H⁺. The ⁶Li⁺, D⁺, H⁺, and ³H⁺ ions all move to the negatively charged center (Pd) electrode post, while the Cl⁻ and O⁻ ions move toward the positively charged (Pd) outer rim cylindrical electrode. During this ionic migratory process, the ⁶Li⁺ ions combine with the Cl⁻ ions to form the compound LiCl which precipitates out of solution, while two O⁻ ions form O₂ gas at the outer positive (Pd) cylindrical electrode. Likewise, two H⁺ ions form H₂ gas, which also bubbles out of solution at the negatively charged center (Pd) electrode post. The D⁺ deuterium ions and the tritium (³H⁺) ions are attracted to the negatively charged center (Pd) electrode post, where some may combine together and escape as D₂ gas, while other D⁺deuterium ions get absorbed into the negatively charged (Pd)'s surface lattice structure. This absorption overcomes the Coulomb repulsive force between the two deuterium nuclei and squeezes them (D⁺)+(D⁺) together forming a helium ⁴He atom and energy. A deuterium ion (D⁺) can also fuse with a tritium ion (³H⁺) to form a helium ⁴He atom, a rogue neutron n, and energy (See picture insert)¹. 1. Retrieved from: “(http://en.wikipedia.org/wiki/Space_and_Naval_Warfare_Systems_Center_San_Diego”

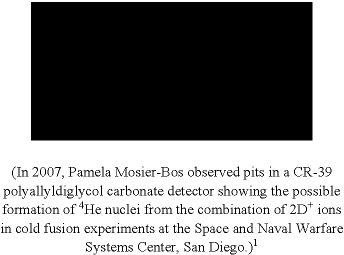

This fusion process given by;

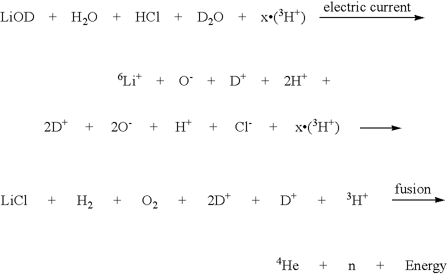

whereby, energy is released. According to Einsteins famous equation, E=m·c², the amount of released energy is equal to the small amount of matter lost during the fusion process. When two deuterium atoms combine to form a Helium atom, the mass difference can be calculated by:

$$\frac{\begin{matrix}{D}^{+} = 2.1066 a . m . u \\ + {D}^{+} = 2.0166 a . m . u\end{matrix}}{\underline{\begin{matrix}Total mass = 4.0332 a . m . u \\ - Helium ' s mass = 4.0030 a . m . u\end{matrix}}}$$

leaving a mass difference of=0.0302 a.m.u., which is converted to energy. This amount of energy released for each atom of ⁴He produced, is given by:

$${1.66 \times {10}^{- 27} ( kg / a . m . u )}^{( conversion factor )} \times 0.0302 a . m . u = {0.05 \times {10}^{- 27} kg}^{( loss of mass )} \times {{( 3.00 \times {10}^{8} )}^{2}}^{( speed of light )} = {4.5 \times {10}^{- 10} joules}_{( energy released )} = 28.1 Mev .$$

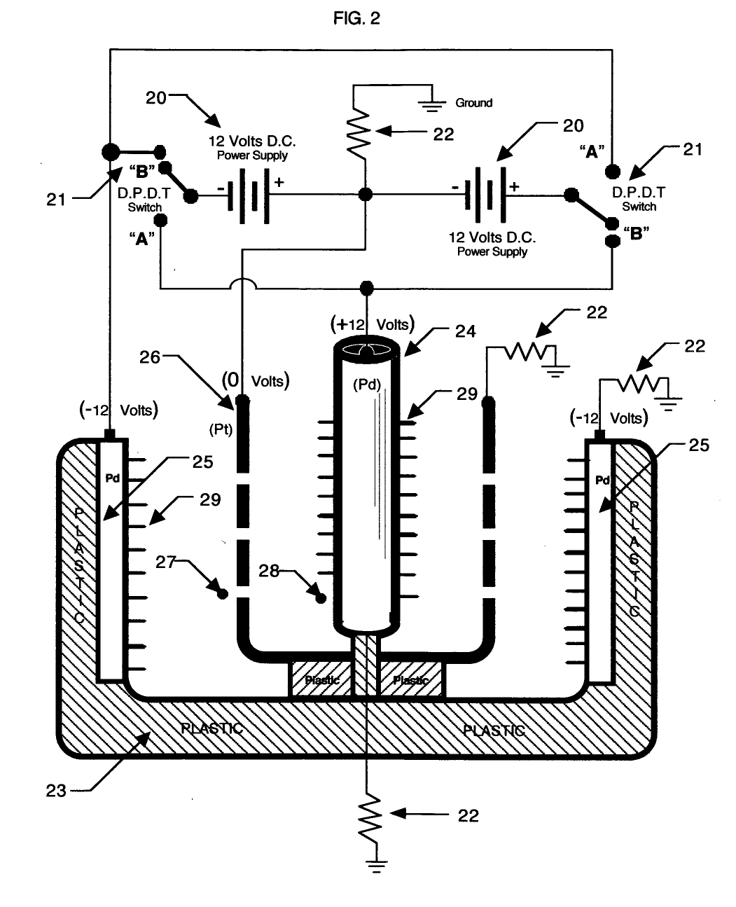

When the D.P.D.T. switch is flipped to position “B”, FIG. 2, the polarities on the cell's (Pd) electrodes are reversed, causing the outer (Pd) cylindrical electrode to now become negatively charged at −12 volts, while the center (Pd) electrode post becomes positively charged at +12 volts, while the middle (Pt) cylindrical electrode remains at a zero volt potential. This causes the ion migration to reverse direction. Thus the D⁺, 3H⁺ and ⁶Li⁺ ions will now move toward the negatively charged outer rim cylindrical (Pd) electrode, while the O⁻ and Cl⁻ ions will now be attracted to the center positively charged (Pd) post electrode. Cold fusion of deuterium will now occur at the cylindrical (Pd) rim electrode, while O₂ escapes as a gas from the center (Pd) electrode. Whereby, constantly alternating the cell's (Pd) palladium polarities using the (D.P.D.T.) switch, a steady flow of fusion energy can be produced; first at the central post electrode when the D.P.D.T. switch is in position “A”, and then at the outer palladium electrode when the D.P.D.T. switch is in position “B”.

According to the design of the Tamian Fusion Cell, the middle (Pt) platinum electrode acts as an ion “kicker” that facilitates the ion migration between both palladium electrodes, as their polarities change. The (D⁺) ions get accelerated toward the negative (Pd) electrode where they impact into the surface of the metal, fusing into an atom of (⁴He) by overcoming their nuclear repulsive coulomb forces, and produces energy. The “double-pole double-throw” switch may be replaced by an Integrated timing circuit that will automatically control and govern the amount of fusion energy being produced by regulating the number of polarity flips to the palladium (Pd) electrodes. The frequency and time between polarity shifts of the I.C. are determined by the time the (D⁺) and O⁻ ions take to reach their appropriate palladium (Pd) electrodes and produce maximum fusion during one cycle. The (Pd) electrode surfaces are designed with thin protruding palladium villi, extending radially outward into the electrolytic solution. This creates more exposed surface area so that more fusion may occur. The escaping O₂ gas, formed at the positively charged (Pd) electrode, will clean it as it bubbles out of solution, preventing any lithium and deuterium build up and contamination. The chlorine ion, liberated from the HCl, combines with the lithium to form LiCl, which also prevents some lithium contamination.

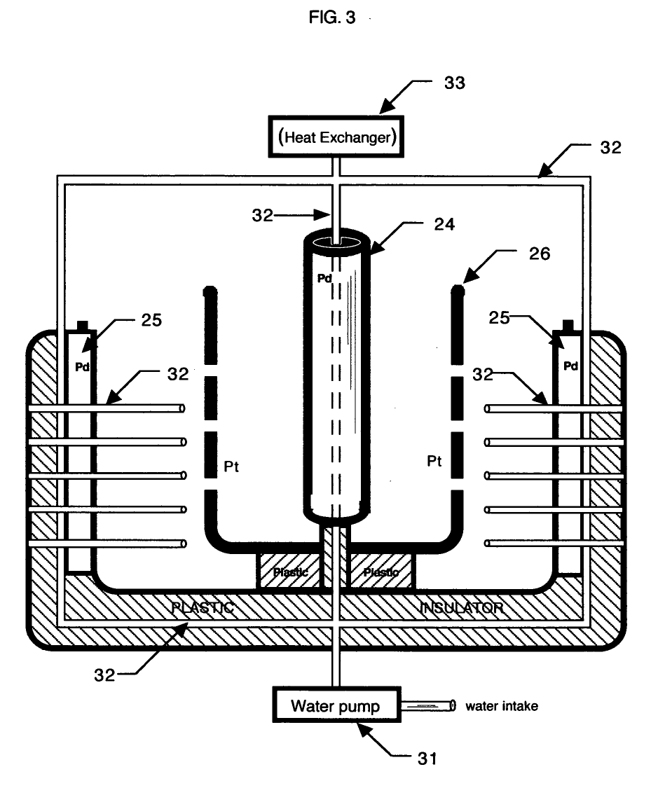

Water tubes 32 are placed behind the outer cylindrical rim (Pd) electrode, while another tube is inserted through the axial center of the central (Pd) post electrode, still more tubes may spiral around the circumference of the cell. Water is pumped through these tubes. The heat generated by fusion in the metal (Pd) surfaces will be conducted to the circulating water flowing inside these tubes, which is then transferred to an outside heat exchanger device, FIG. 3. The load resistors 22 and the plastic bases of the electrodes prevent any electrical short-circuiting in the cell.

Presently, no electrolytic cold fusion cell exists that can produced any significant amounts of energy at the atomic level. However, if deuterium fusion does occur in the crystal lattice structure on the (Pd) electrode's surface, as predicted by Stan Pons and Martin Fleischmann in 1989, then the Tamian Fusion Cell solves the inherit problems that prevented older style fusion cells from functioning, and will operate as a valid cold fusion energy cell.

What I claim as my invention is:

1. The Tamian Fusion Cell is a uniquely designed electrolytic cell which consists of an outer cylinder made of heat resistant plastic with an inside cylindrical layer of palladium (Pd); a middle perforated cylinder made of platinum (Pt) with a plastic base; and a central palladium (Pd) post also mounted on a plastic base, whereas these said metal electrodes are connected to a “dual-polarity” power supply by a “double-pole double-throw” switch, which may be replaced by an “integrated timing circuit”, whereby said cell is partially filled with an electrolytic solution consisting of water (H₂O), heavy water (D₂O), Lithium deuterium oxide(LiOD), diluted Hydrochloric acid (HCl), and added tritium ions (³H⁺), which dissociates into ⁶Li⁺+2O⁻+2D⁺+2H⁺+Cl⁻+H⁺+O⁻+x·(³H⁺) ions when an electric current is passed through the electrolytic solution, whereby two D⁺ ions are caused to fuse together at the surface of the negative palladium electrode producing an atom of ⁴He and energy, while diatomic oxygen O₂ forming at the positive palladium electrode, cleans it as said O₂ bubbles out of solution as a gas, and passing through the center of said central palladium electrode is a water tube which is connected to other water tubes passing behind the palladium lining of the outer cylindrical electrode's inner surface, whereby water is pumped through said tubes to a heat exchanger device located outside the cell.

2. The “dual-polarity” power supply, as described in claim 1, is a direct current power supply with an output ranging from 6 volts D.C. to 24 volts D.C., of which 12 volts is shown here.

3. The “double pole-double throw” switch, as described in claim 1, when placed in position “A”, connects the positive terminal of the “dual polarity” power supply to the cylindrical outer rim palladium electrode, while connecting the ground lead of the “dual-polarity” power supply to the middle cylindrical platinum electrode, and finally connecting the negative terminal of the “dual polarity” power supply to the center palladium electrode post of the cell.

4. The “double-pole double-throw” switch, as described in claim 1, when toggled to position “B”, reverses the polarities of the (Pd) palladium electrodes from position “A”, wherein the negative terminal of the “dual-polarity” power supply is now connected to the cylindrical outer rim palladium electrode, while the ground lead of the “dual-polarity” power supply remains connected to the middle cylindrical platinum electrode, and finally the positive terminal of the “dual-polarity” power supply is now connected to the center palladium electrode post of the cell.

5. The water being pumped through the tubes, as described in claim 1, is used to transfer the heat energy, which is produced at the metal palladium electrodes during the fusion process of deuterium into helium, to an outside energy exchange device.

6. An integrated timing circuit, as described in claim 1, may replace said “double-pole double-throw” switch, whereby automatically and constantly flipping the palladium electrodes' polarities within a certain time interval, wherein the frequency and time period between polarity shifts of said integrated timing circuit are determined by the time the D⁺ and O⁻ ions take to reach their appropriate palladium (Pd) electrodes and produce maximum fusion during one cycle, whereby regulating the amount of heat produced by the Tamian Fusion Cell.

7. Both the center palladium electrode and the outer cylindrical palladium electrode, as described in claim 1, have small thin protruding villi extending radially outward into the electrolytic solution, whereby increasing the exposed surface area of said electrodes, where more fusion of deuterium can readily take place.

8. The middle platinum electrode, as described in claim 1, acts as an ion “kicker” each time the polarities of the palladium (Pd) electrodes flip, whereby being negative to the positive (⁺12) volt (Pd) electrode and, at the same time, being positive to the negative (⁻12) volt (Pd) electrode, whereby facilitating the ion migration between said palladium electrodes. Accordingly the (D⁺) ions get accelerated toward the negative (⁻12) volt (Pd) palladium electrode such that they collide with said (Pd) metal surface with greater momentum and impact, whereby producing a maximum amount of fusion.

9. The escaping diatomic oxygen, as described in claim 1, cleans the presently active positive palladium electrode from any buildup of contaminants on said electrode, as said oxygen bubbles out of solution.
